(19) United States
(12) Patent Application Publication
(10) Pub. No.: US 2012/0054055 A1
(43) Pub. Date: Mar. 1, 2012

(54) Application Mall System with Flexible and Dynamically Defined Relationships Between Users

(75) Inventors: Nino Vidovic, Saratoga, CA (US); Guangbin Fan, Santa Clara, CA (US); George Vanecek, JR., Madison, WI (US); John Waclawsky, Bartlett, IL (US)

(73) Assignee: FUTUREWEI TECHNOLOGIES, INC., Plano, TX (US)

(21) Appl. No.: 13/212,892

(22) Filed: Aug. 18, 2011

Related U.S. Application Data
(60) Provisional application No. 61/378,686, filed on Aug. 31, 2010.

(51) Int. Cl. G06Q 30/00

(52) U.S. Cl. 705/26.1

(57) ABSTRACT

A system comprising a network infrastructure configured to instantiate and implement an application mall supporting a plurality of users, wherein the application mall provides customers access to online stores that provide digital goods, wherein relationships between the plurality of users are flexible and are dynamically defined by at least some of the plurality of users.

### CROSS-REFERENCE TO RELATED APPLICATIONS

The present application claims the benefit of U.S. Provisional Patent Application No. 61/378,686 filed Aug. 31, 2010 by Nino Vidovic et al. and entitled “Brandable, Multi-Tenant Application Mall Instances with Generalized Business Models,” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

The development and proliferation of mobile applications and digital content is rapidly evolving. Efforts are being made to allow the Internet to offer a convenient and effective venue for application developers and their partnered service and content providers to effectively distribute and market their applications and content. This represents a challenge in the mobile application world, which has a large amount of diversity and personalization resulting in a substantially complex environment. Additionally, the application development and content community may not have a convenient or efficient way to locate and engage end users who may be interested in their products and services over the Internet. For example, devices, applications, and content may not be easily located, purchased, and used to meet different aspects of the substantial large variety of individual needs. Thus, the potential of electronic commerce (e-commerce) for software applications and content is not being fully realized in the current commercial Internet.

### SUMMARY

In one embodiment, the disclosure includes a system comprising a network infrastructure configured to instantiate and implement an application mall supporting a plurality of users, wherein the application mall provides customers access to online stores that provide digital goods, wherein relationships between the plurality of users are flexible and are dynamically defined by at least some of the plurality of users.

In another embodiment, the disclosure includes a network component comprising one or more processors configured to implement an application mall program that supports a plurality of business models for a plurality of stores that are configurable by a plurality of users using a plurality of offered mall services, wherein the application mall supports a plurality of online stores, wherein relationships between users are flexibly and dynamically defined by the users.

In yet another embodiment, the disclosure includes a network apparatus implemented method comprising providing, with at least one processor, a user access to a group of services in an application mall, wherein the application mall provides access to a plurality of online stores that provide digital goods, and wherein the group of services provide the user with options for configuring the application mall, receiving a user selection of an option from the group of services and configuring relationships between at least two users of the application mall based on the user selection.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of an application mall architecture.

FIG. 2 is a schematic diagram of an embodiment of mall users and mall services.

FIG. 3 is a flow diagram of an embodiment of a method for accessing registered user services.

FIG. 4 is a flow diagram of an embodiment of a method for accessing mall customer services.

FIG. 5 is a flow diagram of an embodiment of a method for accessing store owner services.

FIG. 6 is a flow diagram of an embodiment of a method for accessing application developer services.

FIG. 7 is a flow diagram of an embodiment of a method for accessing content provider services.

FIG. 8 is a flow diagram of an embodiment of a method for accessing mall administrator services.

FIG. 9 is a schematic diagram of an embodiment of a method for mall and store services subscription.

FIG. 10 is a schematic diagram of an embodiment of a transmitter/receiver unit.

FIG. 11 is a schematic diagram of an embodiment of a general-purpose computer system.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

As technology expands and technology usage grows, it may be advantageous to ensure business models with flexibility and avoid dated and more difficult to change business models. Business models may evolve rapidly and new models may appear frequently, e.g., as technology changes. For some new businesses, previous familiar business models may become obsolete, and new models may be needed. The business model may be a substantially important element to the success of the business, where in some cases the innovation may rest in the business model instead of the product or service provided. For example, e-commerce has created new business models that depend substantially on existing or emergent technology.

Disclosed herein is a system and methods to enable application developers and their partnered service and content providers to effectively distribute and market their applications and content and provide diversity and personalization to end users, including customers and store owners. The system and methods may comprise using an application program shopping mall, referred to herein as an application mall, to implement flexible business models that provide economic value to using current or new technologies, such as for Internet and mobile communications. A mall business model may define the tasks by which an electronic mall delivers value to customers (e.g., retailers, suppliers, and/or shoppers), manages relationships with the (electronic) stores in the mall, provides services to the stores, entices customers to visit the mall, handles other mall services, or combinations thereof. The mall business model may also reflect information about what mall users want, how the users want it, and how to organize processes to best meet those needs of the users, get paid for providing what the users need, and make a profit.

The application mall may provide flexibility to support wide variations in business models that may exist online. As such, different mall business models may be similar to variations of recipes. An effective mall business model recipe may provide a base for experimentation and change by creative entrepreneurs. A mall business model may be implemented using a plurality of processes specified by the application mall architecture, such as value creation, delivery, and value capture methods employed by the mall business. The application mall methods may be replicated any number of times as a virtual mall instance within a cloud that offers business opportunities for the mall technology providers. The methods may take advantage of the strengths of cloud environments, which may facilitate experimentation and quick change since clouds provide dynamic, elastic, and flexibly configurable resources, scalable infrastructures, security, virtualization, and multiple application programming interface (APIs) to support hybrid usage scenarios and may also tap into other public and private clouds for additional content and services.

Additionally, the methods may define relationships, products, and service flows between the business entities operating in an online application mall. The system and methods may flexibly broker a combination of products and services in a targeted and organized fashion and facilitate monetary transactions between all parties (e.g., developers, providers, end users, and/or other mall parties) in building, selling, and using software and related content. The disclosed methods may also improve coordination between the typically separate software and services buying activities by enabling any mall party to become a store owner and enabling business models modification by store owners and mall administrators. The methods may also enable better understanding of user needs, easier application discovery, simpler application acquisition, painless provisioning, more enjoyable content consumption, accurate billing, and/or other functions that may be needed for convenient and easy one-stop Internet shopping, which may lead to higher e-commerce revenues and profits.

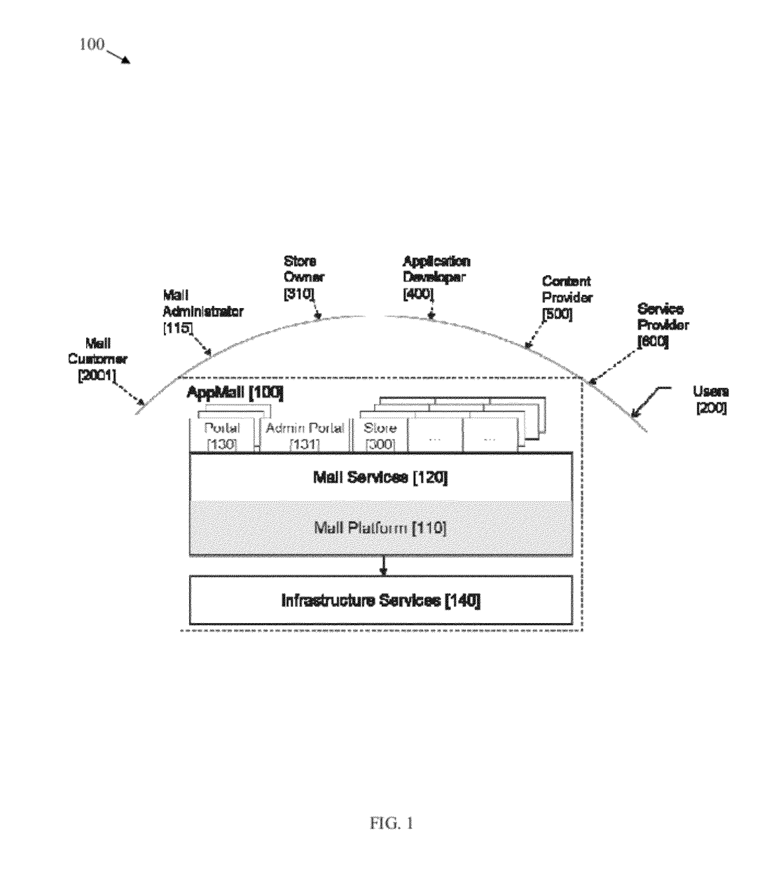

FIG. 1 illustrates an embodiment of an application mall architecture for effectively instantiating a brandable multi-tenant application mall 100 with generalized and flexible business models and stores. The application mall architecture may allow the same or different stores to implement different business models and rapidly change them. Specifically, the application mall 100 may support establishing a flexible and customizable business model methodology, which may allow business associates to dynamically adjust their business models as required. The application mall architecture may comprise the application mall 100 that may be an application program for shopping an online mall and a plurality of mall users 200 that may use the application mall 100.

The application mall 100 may comprise an application mall platform 110 and a plurality of mall services 120, which may both be used to enable a variety of application mall portals 130 for the mall users 200, a plurality of administrator portals 131 for the mall administrators, and a plurality of stores 300 that may be created and offered to customers. The application mall 100 may also comprise a plurality of infrastructure services 140, e.g., network infrastructure services, that may be used to support a plurality of instances, e.g., hosted on a cloud, of the application mall 100. An application mall provides customers with access to a plurality of online stores selling digital goods (e.g., digital content, applications, and/or services).

The mall platform 110 may be a network platform or an infrastructure that comprises network resources. The mall platform 110 may be configured to support a plurality of methods that provide one or more mall operators means to deploy and brand new application malls. Branding allows a user to associate a name with digital content, applications, services, a store, and/or the mall to indicate to a consumer the origin and/or quality of the item associated with the name. The mall platform 110 may also support the different mall services 120, which may be configured and tailored for handling corresponding mall instances. For instance, the mall platform 110 may define how one or more computers that support each cloud hosted instance of the application mall 100 are operated and may determine what software may be used. The mall platform 100 may be configured to target market segments and may be assembled by any vendor with a collection of hardware capabilities, such as processor speed, number of processors, memory and bundled operating system components, features and middleware, and/or other computing resources or components.

The mall users 200 may communicate and view the application mall 100, e.g., as a Web application, with several related portals and dashboards specialized to the various mall users 200, including the application mall portals 130. The mall users 200 may comprise a plurality of mall customers 2001, store owners 310, mall administrators 115, application software developers 400, content providers 500, service providers 600, or combinations thereof. The infrastructure services 140 may be used to implement any number of instances of the application mall 100, such as communication services, server capacity, Internet access, voice and video services, location services, instant messaging, and/or other network services that may be used for supporting the application mall 100.

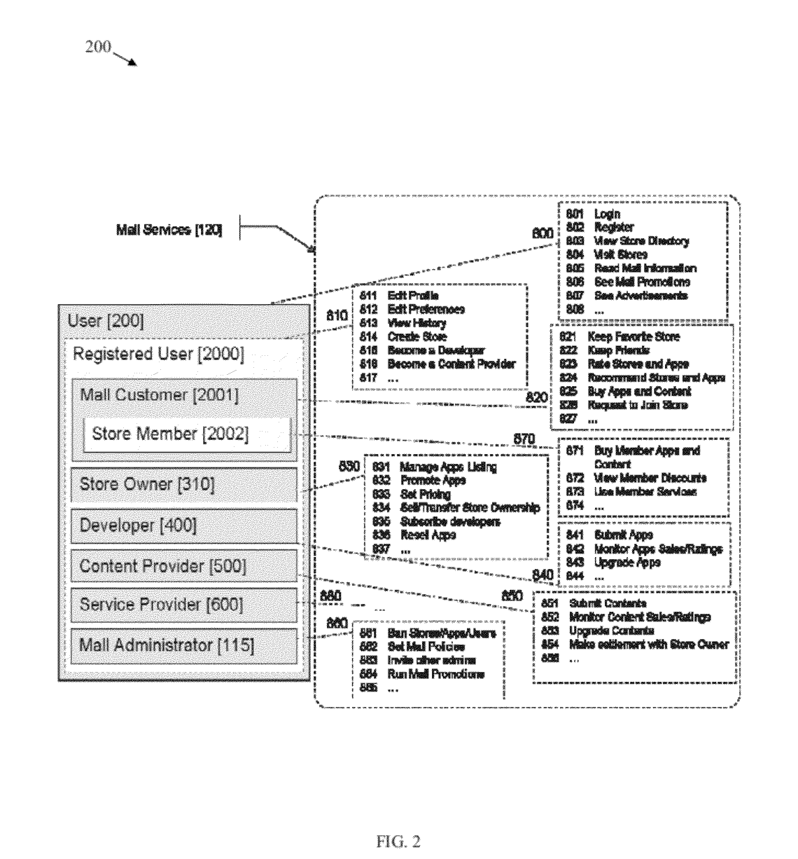

FIG. 2 illustrates an embodiment of a plurality of mall users 200 and mall services 120, which may be part of the application mall architecture 100. The mall services 120 may be offered to the mall users 200 in the application mall 100 and may be organized in a distributed hierarchical structure. Specifically, the mall services 120 may be grouped into a plurality of service groups that may correspond to different mall users 200. The different mall users 200 may comprise one or more registered users 2000. The registered users 2000 may comprise one or more mall customers 2001 that may comprise one or more store members 2002. The registered users 2000 may also comprise one or more store owners 310, one or more developers 400 (e.g., application developers), one or more content providers 500, one or more service providers 600 (e.g., network service providers), one or more mall administrators 115, or combinations thereof.

According to the distributed hierarchical structure, each of the user types or classes may access and use a corresponding service group from the mall services 120, which may be suitable for the user type/class. The service groups may comprise a plurality of basic user services 800 for the mall users 200, a plurality of registered user services 810 for the registered users 2000, a plurality of mall customer services 820 for the mall customers 2001, a plurality of store member services 870 for the store members 2002, a plurality of store owner services 830 for the store owners 310, a plurality of developer services 840 for the developers 400, a plurality of content provider services 850 for the content providers 500, a plurality of service provider services 880 for the service providers 600, and a plurality of administrator services 860 for the mall administrators 115.

All the mall users 200, whether anonymous or registered, may have access to the basic user services 800. The registered users 2000, which may comprise all users known to the mall after their registration, may have access to the basic user services 800 and the registered user services 810. The mall customers 2001, which may be registered users 2000 but not store owners 310, developers 400, content providers 500, service providers 600, and mall administrators 115, may have access to the basic user services 800, the registered user services 810, and the mall customer services 820. The store members 2002 may be mall customers 2001 and registered users 2000 associated with one or more specific stores. For instance, the store members 2002 may subscribe to a store's customer list, e.g., as part of a special interest group (or VIP list). Thus, the store members 2002 may have access to the store member services 870 in addition to the mall customer services 820, the registered user services 810, and the basic user services 800.

The store owners 310, which may be registered users 2000, may create, own, or co-own stores, and may have access to the store owner services 830 and by inheritance to the registered user services 810 and the basic user services 800. The application developers 400 may be part of the registered users 2000 that are registered as such. The application developers 400 may be allowed to submit applications and may have access to the developer services 840 and through inheritance to the registered user services 810 and the basic user services 800. The content providers 500 may be part of the registered users 2000 that are registered as such. The content providers 500 may be allowed to submit digital content and access the content provider services 850 and through inheritance the basic user services 800 and the registered user services 810. The service providers 600 may be part of the registered users 2000 that are registered as such. The service providers 600 may provide applications that support run-time services and may interact with the mall and its customers via the service provider services 880 and through inheritance the basic user services 800 and the registered user services 810. The mall administrator 115 may be part of the registered users 2000 that may have access to the administrator services 860 and through inheritance the registered user services 810 and the basic user services 800.

The basic user services 800 may be available to all mall users 200 irrespective of their roles or status, as described above, and may provide the registered users 2000 a service to login into the mall 801 and for anonymous users a service to register with the mall 802. The basic user services 800 may also provide registered and anonymous users services to view store directory 803, visit store within the mall 804, read mall description, information, and notices 805, see mall promotions 806, see mall related advertisements 807, and/or other available services 808. The registered users 2000 may access additional services in the registered user services 810 that may not be available to anonymous users in the basic user services 800. The additional services may comprise services for users to edit their user profile 811, edit their mall preferences 812, view their mall activity history 813, create new store 814, sign up as a new developer 815, register as a content provider 816, and/or other available services 817.

The mall customers 2001 that may be registered users 2000 may access additional services in the mall customer services 820, which may comprise services for the customers to keep a list of favorite stores 821, keep a list of other mall customers as friends 822, rate stores and applications 823, recommend stores and applications to friends and other mall users 824, buy applications and content 825, and/or other available services 827. The mall customers 2001 may also access the mall customer services 820 and use a service to join a store 826 to become a store member and hence obtain access to the store member services 870. The store members 2002 may access the store member services 870 to use services to view member only store content 872, buy applications and content available only to the members 871, view member discounts and other member related services 873, and/or other available services. These member services and privileges may be specific to and may be different for each store.

The store owners 310 may access the store owner services 830, which may comprise services to allow the owners to manage their application listing 831, promote various applications to public and their members 832, set pricing 833, sell or transfer store ownership 834 to other store owners or other stores, accept developers 835, resell applications 836, e.g., list applications owned by other stores and bundled with a store purchase, and/or other available services 837. The developers 400 may access the developer services 840 to use services to submit applications to the mall or subscribed stores 841, monitor the sales and ratings of their applications 842, upgrade applications 843, and/or other available services 844. The content providers 500 may access the content provider services 850 to use services to submit content 851, monitor the content's sales and ratings 852, update the content 853, make settlement with store owners 854, and/or other available services 855.

The service providers 600 may access the service provider services 880 to use service to offer application on-boarding support to customers, offer new or changed billing plans, offer new equipment, etc. The mall administrators 115 may access the administrator services 860 to use services to ban or deny access to stores, applications, or users 861 from the mall, set mall policies 862, such as security settings, invite other users to be mall administrators 863, run mall promotions 864, and/or other available services 865. One of the allowed services of the mall administrators 115 may be the ability to change the list of services available to all categories of mall users 200 and change the service organization hierarchy, e.g., of FIG. 2.

FIG. 2 shows a possible organization instance of the application mall services 120 of the application mall 100. The mall services 120 may be separated into user roles (according to the different user types/classes), may be shared among users, and may be structured in a distributed hierarchy. Additionally, the mall administrator 115 may change the business model of the application mall, for instance by changing the hierarchy or menus of the service groups in FIG. 2. In other embodiments, the mall users 200 may comprise a subset of the user types/classes above, and hence the mall services 120 may comprise a corresponding subset of the corresponding service groups above. Alternatively, the mall services 120 may comprise other different service groups corresponding to the user types above. In some scenarios, the mall users 200 may comprise additional user types or classes and accordingly the mall services 120 may also comprise additional corresponding service groups, in the same distributed hierarchical structure manner.

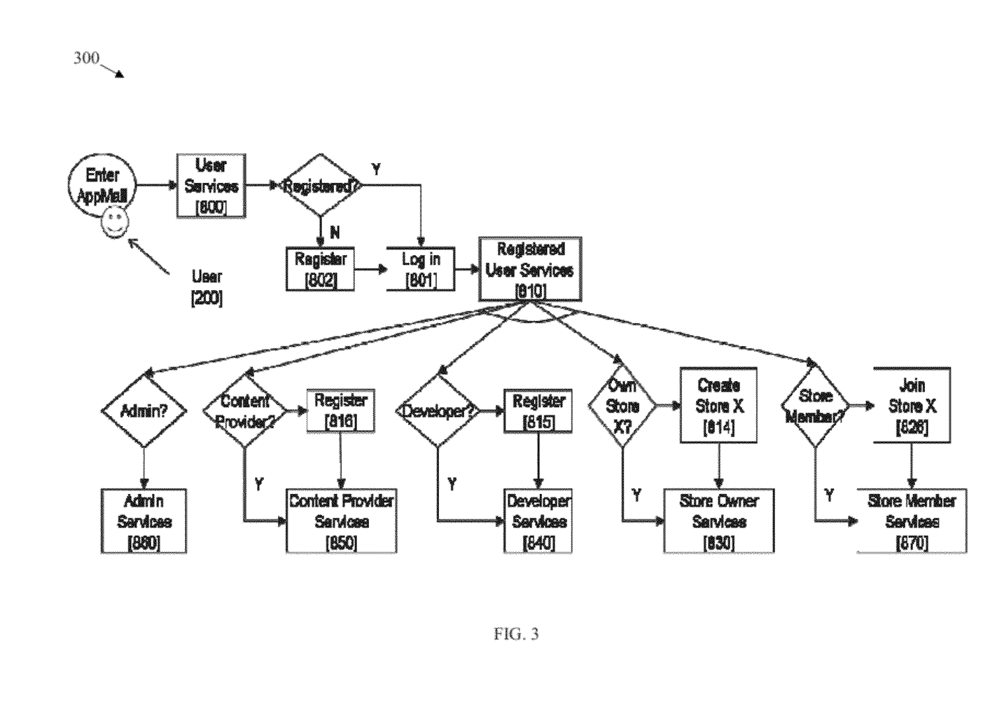

FIG. 3 illustrates an embodiment of a method for accessing the registered user services 810, which may be used in the mall application 100. The method may be used by the mall users 200 to register as registered users 2000 and hence access the registered user services 810. Specifically, the mall user 200 may enter the application mall 100 (using a portal 130) and access and use the basic user services 800. If the mall user is already registered as a registered user 2000, then the registered user 2000 may use the service to login into the mall 801 to access the registered users services 810. Otherwise, the mall user 200 may use the service to register with the mall 802 and hence become a registered user 200. After using the service to login into the mall 801, the registered user 2000 may access and use the registered user services 810.

If the registered user 2000 is also a mall administrator 115, then the mall administrator 115 may access the administrator services 860. If the registered user 2000 is already registered as a content provider 816, then the content provider 816 may access the content provider services 850. Otherwise, the registered user 2000 may use the service to register as a content provider 816 and hence access the content provider services 850. Similarly, the registered user 2000 may access the service provider services 880 as a service provider 600. If the registered user 2000 is already registered as a developer 400, then the developer 400 may access the developer service 840. Otherwise, the registered user 2000 may use the service to sign up as a new developer 815 and hence access the developer services 840. If the registered user 2000 is already registered as a store owner 310, then the store owner 310 may access the store owner service 830. Otherwise, the registered user 2000 may use the service to create new store 814 and hence become a store owner 310 and access the store owner services 830. If the registered user 2000 is already registered as a store member 2002, then the store member 2002 may access the store member services 870. Otherwise, the registered user 2000 may use the service to join a store 826 and hence become a store member 2002 and access the store member services 870.

The registered user 2000 may access and use any number of the different service groups above as long as the registered user 2000 is registered as a corresponding user of that service group. For instance, the registered user 2000 may be registered as a content provider 500, a service provider 600, and a store owner 310, and hence may access and use the content provider services 850, the service provider services 880, and the store owner services 830.

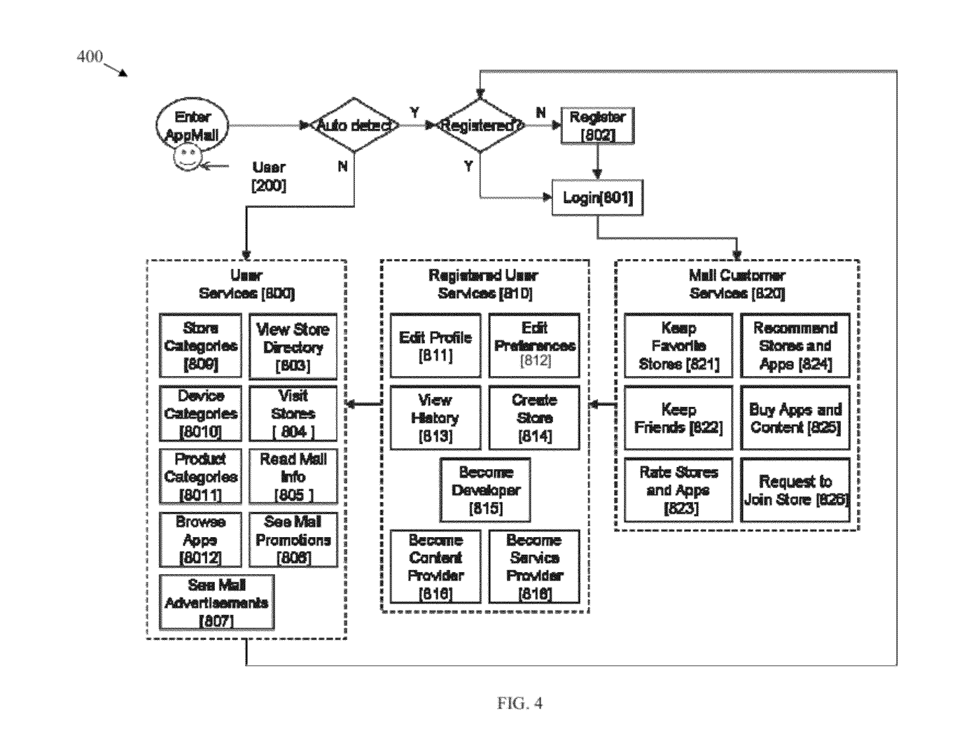

FIG. 4 illustrates an embodiment of a method 400 for accessing the mall customer services 820, which may be used in the mall application 100. The method may be used by the mall users 200 or the registered users 2000 to register as mall customers 2001 and hence access the mall customer services 820. Specifically, the mall user 200 or registered user 2000 may enter the application mall 100, e.g., using a portal 130. If the mall user's 200 access is auto detected in the application mall, then the method may verify if the mall user 200 is registered as a mall customer 2001. If the mall user 200 is already registered as a mall customer 2001, then the mall customer 2001 may use the service to login into the mall 801 to access and use the mall customer services 820. Otherwise, the mall user 2000 may use the service to register with the mall 802 and hence become a mall customer 2001. After using the service to login into the mall 801, the mall customer 2001 may access and use the mall customer services 820 and by inheritance the registered user services 810 and the basic user services 800. As described above, the mall customer services may comprise services to keep favorite stores 821, keep friends 822, rate stores and applications 823, recommend stores and applications 824, buy applications and content 825, and request to join stores 826. The registered user services 810 may comprise services to edit profile 811, edit preferences 812, view history 813, create new store 814, become a developer 815, become a content provider 816, and/or become a service provider 818.

Alternatively, if the mall user's 200 access is not auto detected in the application mall, then the mall user 200 may access and use the basic user services 800. As described above, the basic user services 800 may comprise services to view store directory 803 (of the application mall 100), to visit store 804, to read mall information 805, to see mall promotions 806, and to see mall advertisements 807. The service to view store directory 803 may show the mall user 200 products and services available in the application mall 100, for instance using views such as store categories 809, device categories 8010, product categories 8011, and/or a service to browse applications 8012. The mall user 200 may also be shown products and services available in the application mall 100 that may exist in a mobile device, installed on the mobile device, or selected (“hot”) features. Thus, the mall user 200 or registered user 2000 may use the service to login into the mall 801 to access and use the mall customer services 820 if the mall user 200 or the registered user 2000 is already registered as a mall customer 2001, then the mall customer 2001 may access and use the mall customer services 820. Otherwise, the mall user 2000 may use the service to register with the mall 802 and hence become a mall customer 2001 and access and use the mall customer services 820

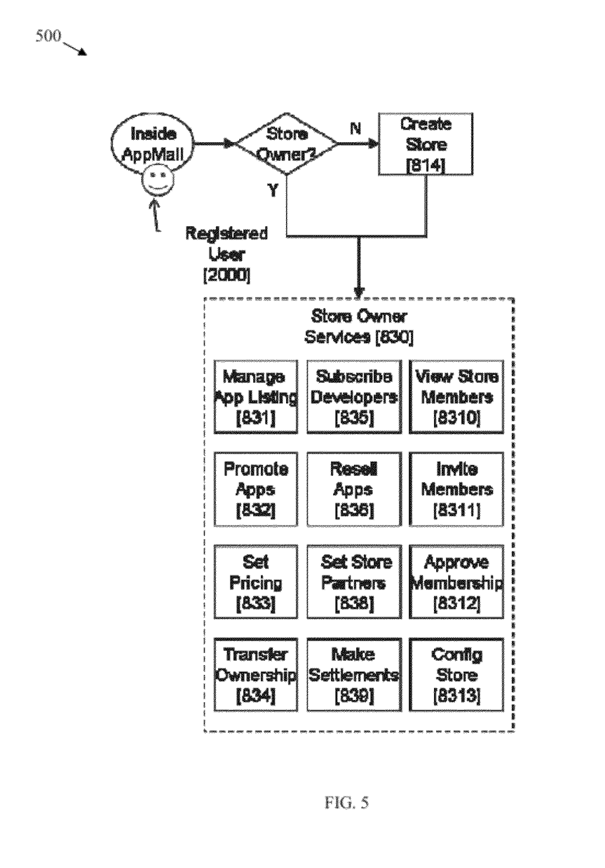

FIG. 5 illustrates an embodiment of a method 501 for accessing the store owner services 830, which may be used in the mall application 100. The method may be used by the mall users 200 or the registered users 2000 to register as store owners 310 and hence access the store owner services 830. Specifically, the mall user 200 or registered user 2000 may enter the application mall 100 using a portal 130. If the registered user 2000 is already registered as a store owner 310, then the store owner 310 may access and use the store owner services 830. Otherwise, the registered user 2000 may use the service to create new store 814 and hence become a store owner 310 and access the store owner services 830. The store owner services 830 may comprise services to manage application listing 831, promote applications 832, set pricing 833, transfer store ownership 834, subscribe developers 835, resell applications 836, set store partners 838, make settlements 839, view store members 8310, invite members 8311, approve membership 8312, and/or configure store 8313.

The mall user 200 or registered user 2000 may become a store owner 310 if the user is considering to open a store 300. Thus, the store owner 310 may be presented with information in the application mall 100, which may comprise past history of application mall activity and activity statistics, the number of available stores 300, break downs into store categories, and/or other store related information. The store owner 310 may also be offered business relationships with links to application developers 400 and/or service providers 600. The store owner 310 may also be offered as part of mall services 120, financial services, support services, and business terms and conditions. Each store owner 310 may independently decide how to market software applications and arrange access to products and services offered by his store 300. The store owners 310 may sell their own applications or resell applications from other stores (using service 836) or application software developers, for instance with new maintenance and support agreements and/or other additional services. This may allow an aggregation of software products to bundle a solution, which may also allow a store 300 to be relatively quickly opened or closed.

Additionally, the store owners 310 may have a choice of which services to use. These services may be offered via the store owner services 830, the registered user services 810, and the basic user services 800. Some of the services in all service groups may be required and others may be optional. Each individual store owner 310 may decide which of the optional mall services to use. By allowing store owners 310 to select and choose the services they want, the mall may be able to support and allow the coexistence of a substantially diverse set of business models and yet maintain efficiency and some level of control by forcing all store owners 310 to use required services.

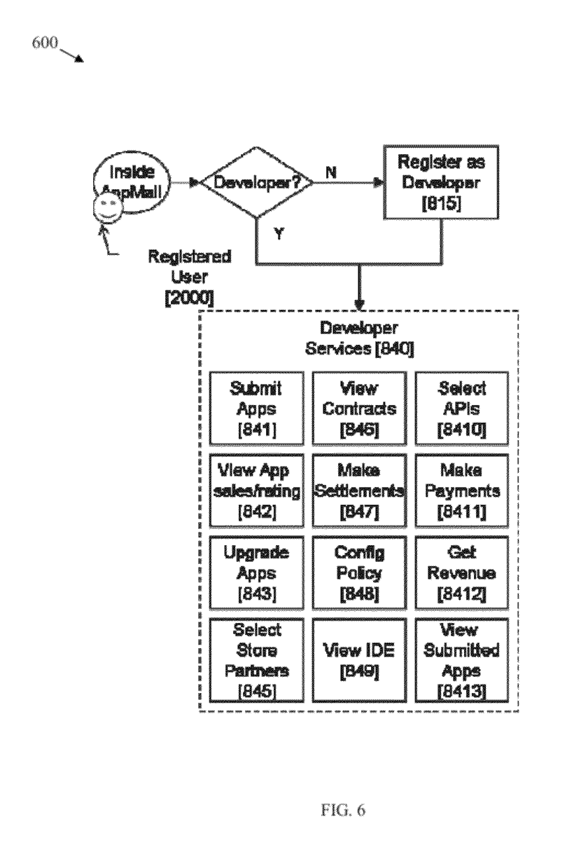

FIG. 6 illustrates an embodiment of a method for accessing application developer services 840, which may be used in the mall application 100. The method may be used by the mall users 200 or the registered users 2000 to register as developers 400 and hence access the developer services 840. Specifically, the mall user 200 or registered user 2000 may enter the application mall 100 using a portal 130. If the registered user 2000 is already registered as a developer 400, then the developer 400 may access and use the developer services 840. Otherwise, the registered user 2000 may use the service to sign up or register as a developer 815 and hence become an application developer 400 and access the developer services 840. The developer services 840 may comprise services to submit applications 841, view application sales/rating 842, upgrade applications 843, select store partners 845, view contracts 846, make settlements 847, configure policy 848, view Integrated development environment (IDE) 849, select APIs 8410, make payments 8411, get revenue 8412, and/or view submitted applications 8413.

The mall user 200 or registered user 2000 may become a developer 400 if the user desires a business relationship with one or more stores 300 or with the application mall 100 to offer applications. Thus, the developer 400 may be presented with information such as the number of shoppers or mall users 200 in the mall, the devices that customers carry and use, statistics on mall customer behavior, existing application software products, the number of stores 300, and/or other information about the stores 300, the mall users 200, and/or the application mall 100. The developer 400 may also be presented business relationships with links to stores 300 that may be interested in the application or software developer's 400 products. Financial services, support services, and business terms and conditions may also be presented as part of mall services 120. Each store owner 310 may independently decide how to market software or jointly market with an application software developer 400. This may allow new products to be relatively quickly provisioned and old products to be deleted.

Additionally, the developers 400 may have a choice of which services to use. These services may be offered via the developer services 840, the registered user services 810, and the basic user services 800. Some of the services in all service groups may be required and others may be optional. Each individual developer 400 may decide which of the optional mall services to use. By allowing application developers 400 to select and choose the services they want, the mall may be able to support and allow the coexistence of a substantially diverse set of business models and yet maintain efficiency and some level of control by forcing all developers 400 to use required services.

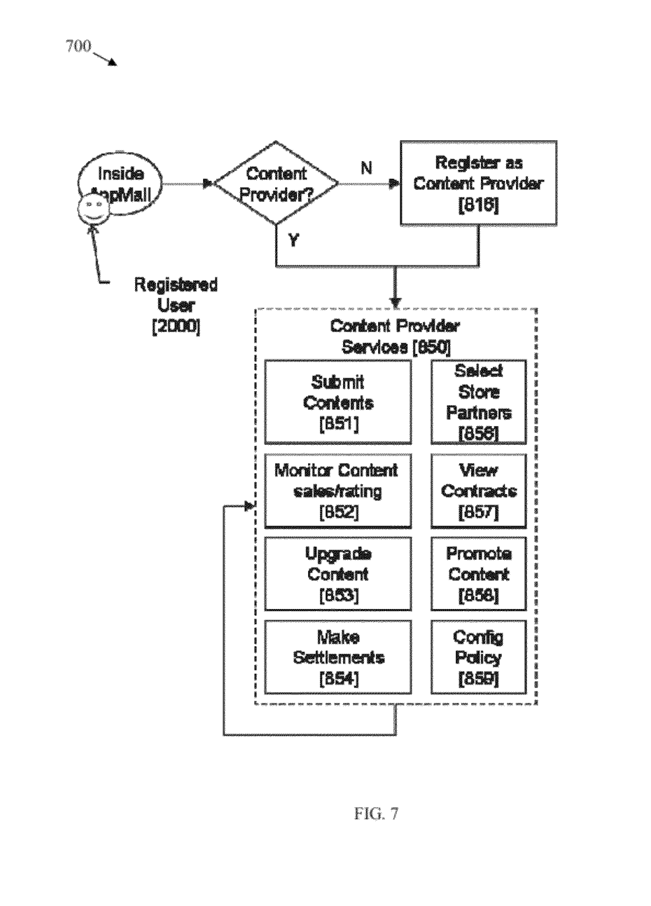

FIG. 7 illustrates an embodiment of a method for accessing content provider services 850, which may be used in the mall application 100. The method may be used by the mall users 200 or the registered users 2000 to register as content providers 500 and hence access the content provider services 850. Specifically, the mall user 200 or registered user 2000 may enter the application mall 100 using a portal 130. If the registered user 2000 is already registered as a content provider 500, then the content provider 500 may access and use the content provider services 850. Otherwise, the registered user 2000 may use the service to register as a content provider 816 and hence become a content provider 500 and access the content provider services 850. The content provider services 850 may comprise services to submit contents 851, monitor content sales/rating 852, upgrade content 853, make settlements 854, select store partners 856, view contracts 857, promote content 858, and/or configure policy 859.

The mall user 200 or registered user 2000 may become a content provider 500 if the user desires a business relationship with one or more stores 300 or with the application mall 100 to sell digital media content. Thus, the content provider 500 may be presented with information such as the number of shoppers or mall users 200 in the mall, the devices that customers carry and use, statistics on mall customer behavior, existing application software products, the number of stores 300, and/or other information about the stores 300, the mall users 200, and/or the application mall 100. The content providers 500 may also be presented business relationships with links to stores 300 that may be interested in the content provider's 500 products. Financial services, support services, and business terms and conditions may also be presented as part of mall services 120. Each store owner 310 may independently decide how to market digital media products, such as discount movie tickets or other products, supplied by the content provider 500 or jointly market with a content provider 500. This may allow new products to be relatively quickly provisioned.

Additionally, the content providers 500 may have a choice of which services to use. These services may be offered via the content provider services 850, the registered user services 810, and the basic user services 800. Some of the services in all service groups may be required and others may be optional. Each individual content provider 500 may decide which of the optional mall services to use. By allowing content providers 500 to select and choose the services they want, the mall may be able to support and allow the coexistence of a substantially diverse set of business models and yet maintain efficiency and some level of control by forcing all content providers 500 to use required services.

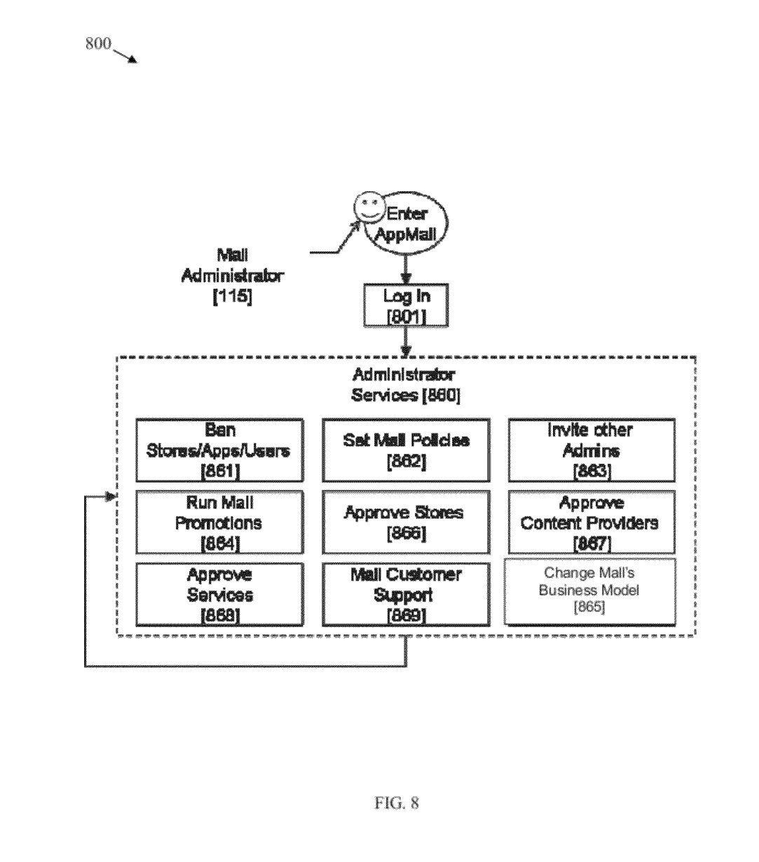

FIG. 8 illustrates an embodiment of a method for accessing mall administrator services 860, which may be used in the mall application 100. The method may be used by the mall administrator 115 to access the administrator services 860. Specifically, the administrator 115 may enter the application mall 100, e.g., using an administrator portal 131. The administrator 115 may then use the service to login into the mall 801 to access and use and use the administrator services 860, which may comprise services to ban stores/applications/users 861, set mall policies 862, invite other administrators 863, run mall promotions 864, approve stores 866, approve content providers 867, approve services 868, provide mall customer support 869, and/or change the mall's business model 865. Mall services may be changed by the mall administrator 115 using the service 860 and may be dynamically added or deleted and relatively quickly offered/changed or removed for mall users 200 or registered users 2000. The mall services may take effect immediately after being added or may be programmed to be triggered at a specific time and date to support changing needs of the mall (e.g., store openings, closings, promotions, holiday sales, etc.).

A mall administrator 115 with proper credentials may change the business model operation of the mall. This may be done in several ways. For instance, a mall administrator 115 may specify what mall services 120 are required and which are optional within a services property field attached to each service offered by the mall services 120 and each of the service groups 800, 810, 820, 830, 840, 850, 860, 870, 880, and/or other service groups that may be used in the application mall 100. The mall administrator 115 may change the settings in service property fields and may change the service groupings and services within each service group offered. Service changes may be done in two ways. Services may be added or deleted from any service group. The inheritance properties of the services may be modified through flag or pointer settings, e.g., in a services access control table. Additionally or alternatively, individual services may be offered to selected mall users 200 and identified with start and expiration date. The services access control table may list all services in any of a number of field sort orders. Services properties may be accessed with proper credentials and changed to allow access by the appropriate user groups (e.g., user types or classes).

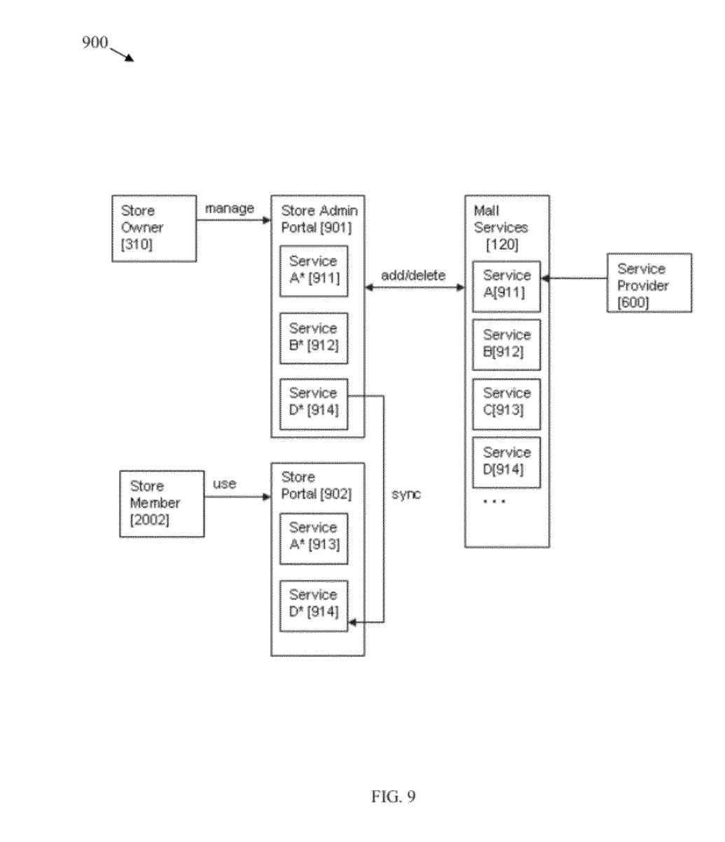

FIG. 9 illustrates an embodiment of a method for mall and store services subscription. The method may allow store owners 310 to configure store services from a plurality of offered mall service 120 and allow store members 2002 to access and use the configured services. Specifically, a store owner 310 may obtain a subset of services from a set of mall services 120 (e.g., service A 911, service B 912, service C 913, service D 914, . . . ), which may be offered by a service provider 600, via a store administrator portal 901. The store owner 310 may configure the store administrator portal 901 by selecting which of the mall services 120 to include. For example, the store administrator portal 901 may comprise service A 911, service B 912, and service D 914 only. The subset of mall services 120 configured or selected by the store owner 310 may correspond to the store owner services 830.

The subset of services may be offered by the store owner 310 to its store members 2002. As such, a store member 2002 may use any of the selected subset of the services by accessing such services via a store portal 902. The store portal 902 may present the store member 2002 all or some of the services in the store administrator portal 901. The services presented to the store member 2002 may correspond to the store member services 870. The store owner 310 may specify the access rights to the services to different store members 2002, for instance by offering different subsets of services in different store portals 902 for different store members 2002.

The application mall's 100 architecture, which includes its the distributed hierarchical structure, and the methods described above may simultaneously support a substantially large number of mall users, diverse stores, applications for a wide range of mobile platforms, supporting services, content providers, and developers in any combination of business relationships. The distributed hierarchical structure and methods may also provide substantial flexibility to support a substantially wide variety of concurrent business models. By allowing store owners to pick and choose the services they want, the mall may be able to support and allow the coexistence of a substantially diverse set of business models. The same may also apply for application developers, content providers, and service provides. The mall architecture and methods may also support a substantial variety of concurrent business models while maintaining some level of control by forcing all store owners, developers, and content/service providers, to use required services. By forcing all store owners, developers, and content/service providers to use required services, a substantial variety of concurrent business models may also be supported while optimizing the efficiency of overall mall operations. Additionally, this architecture and the methods above may allow each store to individually modify and change their store business models, e.g., through experimentation or by allowing each store to respond quickly with products and services that leverage new and changing technology along with individual customer needs.

Additionally, the mall system and methods may offer differentiated services to various classes of application mall users or to individual users, as described above. Multiple mall services may also be dynamically added or deleted and relatively quickly offered/changed or removed for various classes of mall users. Services changes may take effect immediately or may be programmed to be triggered at a specific time and date to support different situations (e.g., store openings, closings, promotions, holiday sales). The system and methods may also provide substantially improved and relevant personalization to users, where shopping efficiency may be improved or maximized since only useful installable products and services of interest may be presented to users. This may reduce or minimize the effort needed by the user to find relevant applications.

These systems and methods may also allow mall users to create online stores relatively quickly, provide users branded store environments, allow service/content providers' offerings to be bundled with application software purchases, and allow the mall to implement provisioning as a service. For instance, back office processes may be part of the service a mall owner provides to stores that opt-in. Further, stores may be enabled to become a one-stop shop for application development, assistance, and maintenance, application and content control may be allowed by individual store owners, such as usage based billing and reseller relationships, and a complete package of commercial services and revenue sharing options may be provided for developers, application store, resellers, and/or mall owners. The system and methods above may also be used to create application malls that are replicable with relative ease and rebrandable as virtual instances in hosted cloud.

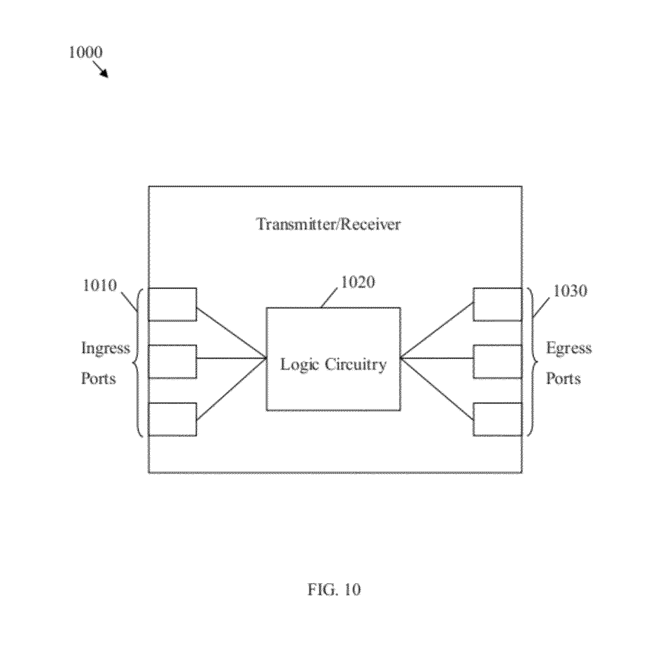

FIG. 10 illustrates an embodiment of a transmitter/receiver unit 1000, which may be any device that transports data, such as in the form of packets, through a network. For instance, the transmitter/receiver unit 1000 may be located in any of the network component in the network infrastructure of the application mall 100. The transmitted/receiver unit 1000 may comprise one or more ingress ports or units 1010 for receiving packets, objects, or Type Length Values (TLVs) from other network components, logic circuitry 1020 to determine which network components to send the packets to, and one or more egress ports or units 1030 for transmitting frames to the other network components. The logic circuitry 1020 may also implement or support the implementation of any of the methods described above.

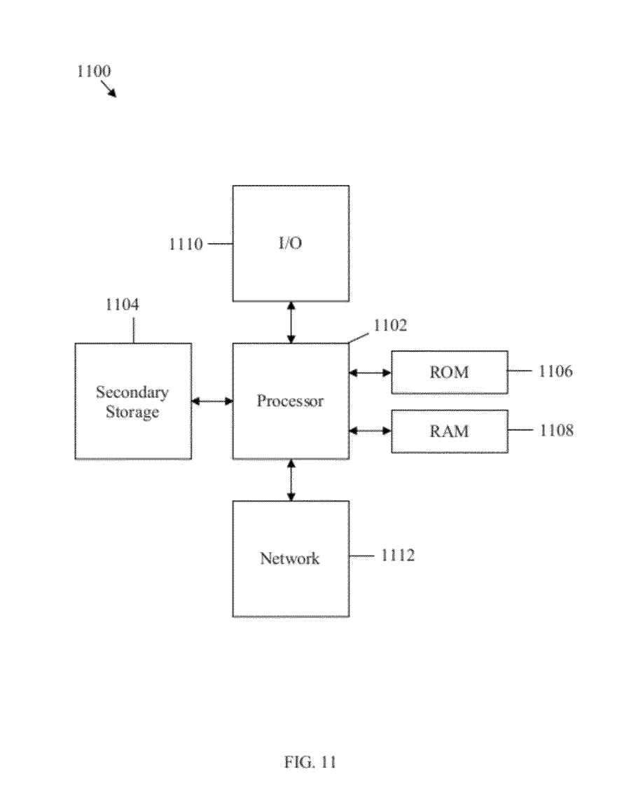

The network components and/or methods described above may be implemented on any general-purpose network component, such as a computer or network component with sufficient processing power, memory resources, and network throughput capability to handle the necessary workload placed upon it. FIG. 11 illustrates a typical, general-purpose network component 1100 suitable for implementing one or more embodiments of the components disclosed herein. The network component 1100 includes a processor 1102 (which may be referred to as a central processor unit or CPU) that is in communication with memory devices including secondary storage 1104, read only memory (ROM) 1106, random access memory (RAM) 1108, input/output (I/O) devices 1110, and network connectivity devices 1112. The processor 1102 may be implemented as one or more CPU chips, or may be part of one or more application specific integrated circuits (ASICs).

The secondary storage 1104 is typically comprised of one or more disk drives or tape drives and is used for non-volatile storage of data and as an over-flow data storage device if RAM 1108 is not large enough to hold all working data. Secondary storage 1104 may be used to store programs that are loaded into RAM 1108 when such programs are selected for execution. The ROM 1106 is used to store instructions and perhaps data that are read during program execution. ROM 1106 is a non-volatile memory device that typically has a small memory capacity relative to the larger memory capacity of secondary storage 1104. The RAM 1108 is used to store volatile data and perhaps to store instructions. Access to both ROM 1106 and RAM 1108 is typically faster than to second storage 1104.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R₁, and an upper limit, Rᵤ, is disclosed, any number falling within the range is specifically disclosed. In particular, the following numbers within the range are specifically disclosed: R=R₁+k*(Rᵤ−R₁), wherein k is a variable ranging from 1 percent to 100 percent with a 1 percent increment, i.e., k is 1 percent, 2 percent, 3 percent, 4 percent, 7 percent, . . . , 70 percent, 71 percent, 72 percent, . . . , 97 percent, 96 percent, 97 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A system comprising:
a network infrastructure configured to instantiate and implement an application mall supporting a plurality of users, wherein the application mall provides customers access to online stores that provide digital goods,
wherein relationships between the plurality of users are flexible and are dynamically defined by at least some of the plurality of users.

2. The system of claim 1, wherein the users are classified in a distributed or hierarchical structure that associates a plurality of user classes with a plurality of corresponding service groups from the mall services.

3. The system of claim 2, wherein the distributed or hierarchical structure and the service groups are dynamically configurable by a user from the plurality of users.

4. The system of claim 1, wherein the application mall supports a dynamic business model methodology for a plurality of users.

5. The system of claim 1, wherein the application mall provides a plurality of mall services to the plurality of users.

6. The system of claim 3, wherein configuring the distributed or hierarchical structure and the service groups dynamically allows the user to implement a plurality of dynamic business models for malls that serve the stores and users, and for the stores that serve the users.

7. The system of claim 1, wherein the plurality of users comprise one or more registered users that comprises one or more mall customers., one or more store owners, one or more application developers, one or more content providers, one or more service providers, and one or more administrators, and wherein the customers comprise one or more store members.

8. The system of claim 3, wherein the service groups comprise a group of basic user services accessible by all the users, a group of registered user services accessible by the registered users, a group of mall customer services accessible by the mall customers, a group of store member services accessible by the store members, a group of store owner services accessible by the store owners, a group of application developer services accessible by the application developers, a group of content provider services accessible by the content providers, a group of service provider services accessible by the service providers, and a group of administrator services accessible by the administrators.

9. The system of claim 8, wherein the users comprise one or more anonymous users that are allowed to access the group of basic user services via a portal and use a service to register and join the registered users.

10. The system of claim 8, wherein the registered users access the group of registered user services via a portal, use a service to login into the application mall, and use a second service to register and join the mall customers, the store owners, the application developers, the content providers, or the service providers.

11. The system of claim 10, wherein the mall customers access the group of mall customers and use a third service to register and join the store members.

12. The system of claim 1, wherein the dynamic business model methodology allows different stores to implement different business models, a store from the stores to implement different business models, or both.

13. The system of claim 1, wherein the digital goods comprises one of digital content, applications, and services.

14. A network component comprising:
one or more processors configured to implement an application mall program that supports a plurality of business models for a plurality of stores that are configurable by a plurality of users using a plurality of offered mall services, wherein the application mall supports a plurality of online stores,
wherein relationships between users are flexibly and dynamically defined by the users.

15. The network component of claim 14, wherein the users configure a plurality of corresponding portals that offer the same or different services that are selected from the same offered mall services to a plurality of customers.

16. The network component of claim 14, wherein the business models are flexibly changed by the users by reconfiguring the corresponding portals with different selected services from the same offered mall services.

17. The network component of claim 14, wherein the users comprise store owners that configure a plurality of corresponding store administrator portals that offer store services to a plurality of store members.

18. The network component of claim 14, wherein the users comprise one or more administrators that configure a plurality of corresponding mall portals that offer a plurality of mall services to a plurality of store members.

19. The network component of claim 14, wherein the store members configure a plurality of corresponding store portals by selecting one or more services from the services offered in the store administrator portals and/or mall services portals.

20. The network component of claim 14, wherein the users comprise application developers that configure a plurality of portals that offer application developer services to the stores, a plurality of store members, or both.

21. The network component of claim 14, wherein the users comprise content providers, service providers or both, that configure a plurality of portals that offer provider services to the stores, a plurality of store members, or both.

22. The network component of claim 14, wherein the users reconfigure the corresponding portals with different selected services from the same offered mall services by adding, deleting, or both adding and deleting different selected services from the same offered mall services, and wherein the changes to the portals take effect immediately after adding or deleting the different services.

23. The network component of claim 15, wherein the users reconfigure the corresponding portals with different selected services from the same offered mall services by adding, deleting, or both adding and deleting different selected services from the same offered mall services, and wherein the changes to the portals are triggered at a determined time and date to support different mall scenarios.

24. A network apparatus implemented method comprising:
providing, with at least one processor, a user access to a group of services in an application mall, wherein the application mall provides access to a plurality of online stores that provide digital goods, and wherein the group of services provide the user with options for configuring the application mall;
receiving a user selection of an option from the group of services; and
configuring relationships between at least two users of the application mall based on the user selection.

25. The network apparatus implemented method of claim 24, wherein providing a user access to a group of services comprises providing a user access to a first group of services in an application mall that does not require registration including a service to register to one of a plurality of user classes.

26. The network apparatus implemented method of claim 25, wherein the user is anonymous to the application mall.

27. The network apparatus implemented method of claim 26, further comprising providing a registered user access to a second group of services in the application mall that requires registration including a service to login into one of the user classes to which the registered user belongs.

28. The network apparatus implemented method of claim 27, further comprising providing an administrator, a store owner, or a content or service provider access to a third group of services in the application mall that is restricted to the anonymous user and the registered user including a service to configure and change the first group of services and the second group of services by at least one of adding, deleting, and changing a plurality of mall services.

29. The network apparatus implemented method of claim 28, wherein configuring and changing the group of services allows branding of a store or a digital good within the application mall, wherein branding provides an association of a user brand name with the store or the digital good.

30. The network apparatus implemented method of claim 28, wherein configuring and changing the group of services provides offering bundling products with application software purchases.

31. The network apparatus implemented method of claim 28, wherein configuring and changing the first group of services and the second group of services allows providing packages of commercial services and revenue sharing options between one or more store owners, content or service providers, mall operators and developers.

32. The network apparatus implemented method of claim 28, wherein configuring and changing the first group of services and the second group of services allows replicating the application mall as a plurality of instances in a cloud.

33. The network apparatus implemented method of claim 24, wherein the digital goods comprises one of digital content, an application, and a service.
